(19) United States
(12) Patent Application Publication
(10) Pub. No.: US 2008/0166268 A1
(43) Pub. Date: Jul. 10, 2008

(54) TEST SHEET, APPARATUS, METHOD AND PROGRAM FOR DIAGNOSING AN OBJECT

(76) Inventors: Hiroshi Yamaguchi, Kanagawa-ken (JP); Hideyasu Ishibashi, Kanagawa-ken (JP); Yoshiki Sakaino, Asaka-shi (JP)

Correspondence Address: BIRCH STEWART KOLASCH & BIRCH, PO BOX 747, FALLS CHURCH, VA, 22040-0747, US

(21) Appl. No.: 11/971,728

(22) Filed: Jan. 9, 2008

(30) Foreign Application Priority Data
Jan. 10, 2007 (JP) 002533/2007

(51) Int. Cl. B01J 19/00; G01N 5/04

(52) U.S. Cl. 422/57; 73/73

(57) ABSTRACT

A test sheet to be adhered to an object at the point of use is disclosed. The test sheet includes: a substrate film including an adhesive layer on one side thereof; a reagent layer disposed on the substrate film on the same side as the adhesive layer, the reagent layer including a reagent, the reagent changing the color thereof depending on an amount of substance evaporating from a surface of the object; a first correction chart disposed on the substrate film on the side opposite from the adhesive layer, the first correction chart being used for correcting color of an image obtained by photographing the object with the test sheet adhered thereto; and a second correction chart used for correcting lightness of the image.

### BACKGROUND OF THE INVENTION

1. Field of the Invention

The present invention relates to a test sheet suitable for measuring a condition of an object such as human skin, an apparatus and method for diagnosing an object using the test sheet, and a computer readable recording medium containing a program for causing a computer to carry out the method for diagnosing an object.

2. Description of the Related Art

Cosmetic stores and esthetic salons are often equipped with an apparatus for measuring skin conditions of customers. Using such an apparatus, they obtain a photographed image of a customer's face to obtain information of the face such as age spots, wrinkles, pores and color of the skin, and sell appropriate cosmetics or apply appropriate treatment based on the information. An example of this type of apparatus for measuring conditions of the face has been proposed in Japanese Unexamined Patent Publication No. 2004-302424.

Further, a sensor for measuring an amount of skin moisture has also been proposed (see Japanese Unexamined Patent Publication No. 2003-169788). Such a sensor has an area to contact the skin to measure a resistance of the skin to estimate the amount of skin moisture.

Furthermore, a test sheet to be adhered to the skin for measuring an amount of moisture evaporating through the skin surface has been proposed. Such a test sheet includes a reagent, such as cobalt chloride, which changes its color depending on the amount of moisture, and the user can check the amount of skin moisture by observing the change of the color of the reagent. Moreover, a test sheet with a reagent for measuring sebum or pH of the skin has also been proposed (see Japanese Unexamined Patent Publication Nos. 2004-236794 and 2005-179314).

However, since the apparatuses for measuring conditions of the face are very large and expensive, it is difficult for an individual to own such an apparatus, and therefore, one have to visit a cosmetic store or an esthetic salon having the apparatus to measure the conditions of the face. Further, since it is necessary to minimize influence of outside light as possible, the user needs to take an unnatural posture so that her or his face is enclosed during photographing. In addition, it is necessary to prepare a separate apparatus, such as one described in the above-mentioned Japanese Unexamined Patent Publication No. 2003-169788, for measuring the amount of moisture and the like.

The apparatus for measuring the amount of moisture is also expensive and it is difficult for an individual to own such an apparatus, and therefore, one have to visit a cosmetic store or an esthetic salon having the apparatus to measure the amount of moisture. Although the above-described test sheet allows the user to readily measure the amount of moisture or the like of the face by adhering the test sheet to her or his face, it is impossible to accurately measure the amount of moisture or the like by only observing the change of the color.

### SUMMARY OF THE INVENTION

In view of the above-described circumstances, the present invention is directed to allow a user to readily check an accurate condition of an object such as skin.

A test sheet according to the invention is adhered to an object at the point of use. The test sheet includes: a substrate film including an adhesive layer on one side thereof; a reagent layer disposed on the substrate film on the same side as the adhesive layer, the reagent layer including a reagent which changes the color thereof depending on an amount of substance evaporating from a surface of the object; a first correction chart disposed on the substrate film on the side opposite from the adhesive layer, the first correction chart being used for correcting color of an image obtained by photographing the object having the test sheet adhered thereto; and a second correction chart used for correcting lightness of the image.

As the reagent, for example, cobalt chloride for measuring an amount of moisture, or BCP (bromcresol purple), MR (methyl red), CRP (chlorophenol red) or PP (phenol purple) for measuring pH can be used.

As the first correction chart, a color chart representing changes of the color of the reagent in a graduated manner can be used. It is preferable to measure and store actual amounts of the substance corresponding to changes of the color of the reagent in the first correction chart in advance.

As the second correction chart, a gray chart including graduated lightness levels can be used.

In the test sheet according to the invention, the substrate film may be made from a material having a refractive index substantially equal to a refractive index of the surface of the object.

As the “material having a refractive index substantially equal to a refractive index of the surface of the object”, if the object is human skin, for example, TAC (triacetyl cellulose) or the like can be used.

Further, in the test sheet according to the invention, the substrate film may have surface characteristics substantially equal to surface characteristics of the object.

If the object is human skin, for example, the substrate film having “surface characteristics substantially equal to surface characteristics of the object” can be obtained by processing the surface of the substrate film to have a texture having the same pitch and depth as those of the human skin. Specifically, a mold is taken from the object (human skin), and the mold is pressed to the material forming the substrate film to provide the substrate film having surface characteristics substantially equal to surface characteristics of the human skin.

An apparatus for diagnosing an object according to the invention includes: image obtaining means for obtaining an image of an object with the test sheet of the invention adhered to a portion thereof; image processing means for correcting color and lightness of the image based on the first and second correction chart contained in the image to obtain a processed image; substance amount measuring means for measuring an amount of a substance evaporating from the surface of the object based on the color of the reagent contained in the processed image; and surface information obtaining means for obtaining information of the surface of the object based on the processed image.

The apparatus for diagnosing an object according to the invention may further include a storing means for storing in a database the amount of the substance and the information of the surface of the object.

The “information of the surface of the object” includes not only information of the surface of the object but also information of the object in a range where visible light can reach, which can be obtained through the surface of the object.

A method for diagnosing an object according to the invention includes: obtaining an image of an object with the test sheet of the invention adhered to a portion thereof; correcting color and lightness of the image based on the first and second correction chart contained in the image to obtain a processed image; measuring an amount of a substance evaporating from the surface of the object based on the color of the reagent contained in the processed image; and obtaining information of the surface of the object based on the processed image.

It should be noted that the method for diagnosing an object according to the invention may be implemented as a computer readable recording medium containing a program for causing a computer to carry out the method.

### BRIEF DESCRIPTION OF THE DRAWINGS

FIG. 1 is a plan view illustrating the structure of a test sheet according to an embodiment of the present invention,

FIG. 2 is a sectional view taken along line I-I in FIG. 1,

FIG. 3 is a sectional view illustrating another example of a substrate film,

FIG. 4 illustrates the test sheet being adhered to the face of a user,

FIGS. 5A and 5B illustrate how self-photographing is carried out,

FIG. 6 is a schematic block diagram illustrating the configuration of a skin diagnostic apparatus according to an embodiment of the invention,

FIG. 7 illustrates positions of skin colors and age spots in a color space,

FIG. 8 is a diagram to explain how a wrinkle detection window is set,

FIG. 9 is a diagram to explain how wrinkles are detected,

FIG. 10 is a one-dimensional profile of signal values,

FIG. 11 is a flow chart illustrating a process carried out by the skin diagnostic apparatus according to the embodiment,

FIG. 12 is a schematic block diagram illustrating the configuration of a diagnostic server,

FIG. 13 is a graph plotting amounts of skin moisture, total areas of age spots and numbers of wrinkles,

FIGS. 14A and 14B illustrate another example of the test sheet (first modification),

FIG. 15 illustrates still another example of the test sheet (second modification),

FIG. 16 illustrates yet another example of the test sheet (third modification), and

FIG. 17 is a diagram to explain how age spots are detected.

### DESCRIPTION OF THE PREFERRED EMBODIMENTS

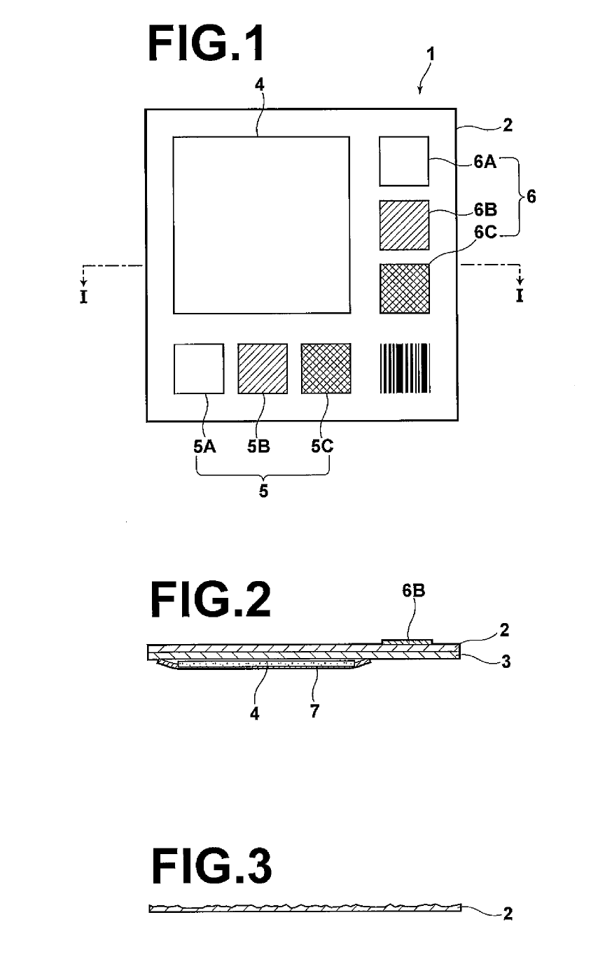

Hereinafter, embodiments of the present invention will be described with reference to the drawings. FIG. 1 is a plan view showing the structure of a test sheet according to an embodiment of the invention, and FIG. 2 is a sectional view taken along line I-I in FIG. 1. As shown in FIGS. 1 and 2, a test sheet 1 according to the embodiment of the invention includes a transparent substrate film 2, an adhesive layer 3 disposed at the lower side of the substrate film 2 for adhering to the skin, and a reagent layer 4 disposed at the lower side of the adhesive layer 3. The reagent layer 4 is formed of cobalt chloride paper containing cobalt chloride as the reagent, which changes its color depending on the amount of moisture evaporating through the skin surface. Further, a first correction chart 5 used for correcting the color of an image obtained as described later and a second correction chart 6 used for correcting the lightness of the image are provided on the upper side of the substrate film 2. A hydrophobic nonwoven fabric 7 covers the lower side of the reagent layer 4.

The substrate film 2 is made from triacetyl cellulose having a refractive index substantially equal to that of the skin surface, however, the substrate film 2 may be made from other resins such as polyolefin, polypropylene or polyester.

The cobalt chloride paper changes its color depending on the amount of absorbed moisture. Specifically, as the amount of absorbed moisture increases, the color of the cobalt chloride paper changes from blue to pale red. Thus, by comparing the color of the cobalt chloride paper adhered to the skin with the first correction chart 5, the amount of moisture evaporating through the skin surface can be measured.

It should be noted that, while the reagent layer 4 containing cobalt chloride as the reagent allows measurement of the amount of skin moisture, it is also possible to measure pH or sebum level of the skin by changing the reagent contained in the reagent layer 4.

The first correction chart 5 is a color chart including color areas 5A-5C of three different colors, for example, blue, pale flesh color and pale red corresponding to changes of the color of the cobalt chloride paper. Specifically, the color area 5A is blue which is similar to the color of the anhydrous salt of cobalt chloride, the color area 5B has pale flesh color which is the color of cobalt chloride when it has absorbed some moisture, and the color area 5C is pale red which is the color of cobalt chloride saturated with moisture.

The second correction chart 6 is a gray chart including gray areas 6A-6C of three different lightness levels corresponding to changes in lightness of the skin.

A bar-code 8 is provided on the surface of the test sheet 1. The type of reagent used in the test sheet 1 can be identified by reading of the bar-code 8.

In this embodiment, the surface of the substrate film 2 may have a texture that is similar to the skin, as shown in FIG. 3. Specifically, the texture similar to the skin can be formed on the surface of the substrate film 2 by taking a mold of the human skin, and when triacetyl cellulose is formed into a sheet, pressing the surface of the sheet with the mold.

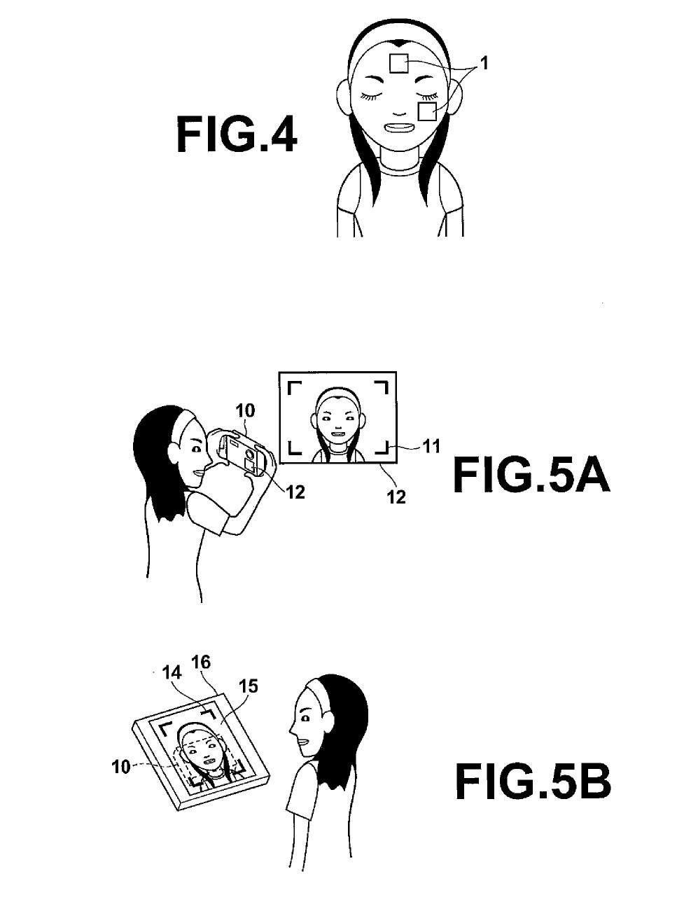

As shown in FIG. 4, the test sheet 1 according to this embodiment is used in a state where it is adhered to the face of the user who intends to measure the amount of moisture of the face. FIG. 4 shows the test sheets 1 being adhered on the forehead and cheek of the user. With the test sheets 1 adhered on the face, the user photographs her or his face with a digital camera.

At this time, as shown in FIG. 5A, it is preferable to provide a mirror 12 for self-photographing, which has a photographing frame 11 on a side thereof facing the photographing lens of the digital camera 10. In this manner, the user can photograph her or his face while looking the mirror 12 so that the image of her or his face fits within the photographing frame 11 of the mirror 12 to obtain an image containing the entire face having a desirable size.

Alternatively, as shown in FIG. 5B, a stand 16 having a light-transmitting mirror 15 for self-photographing, which is provided with a photographing frame 14, may be prepared. In this case, the user sets the digital camera 10 in the stand 16 and photographs her or his face so that the face fits within the photographing frame 14 on the mirror 15. In this manner, an image containing the entire face having a desirable size can be obtained.

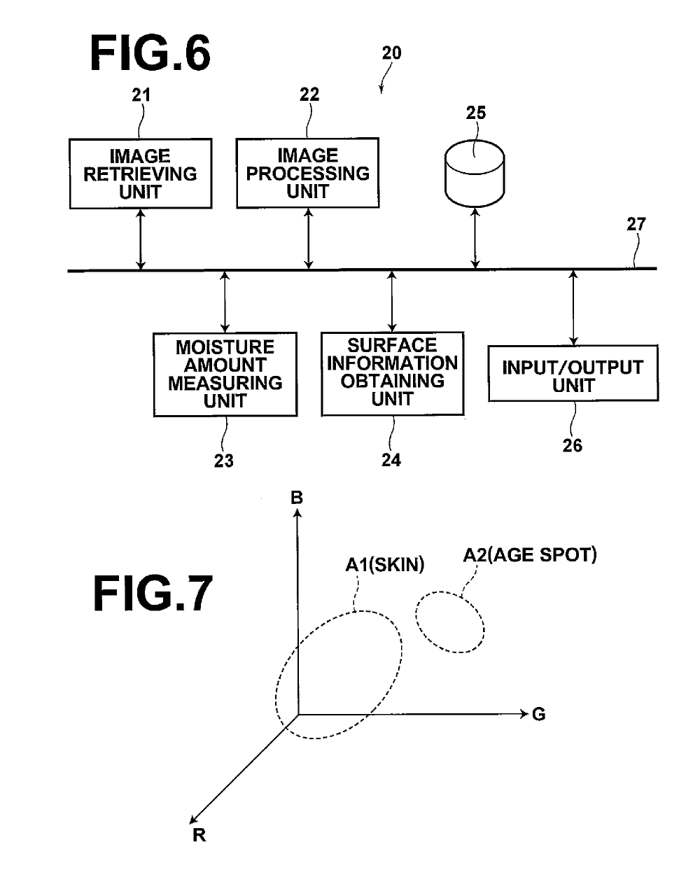

Next, an embodiment of a skin diagnostic apparatus which uses the thus obtained photographed image to carry out diagnosis of the skin will be explained. FIG. 6 is a schematic block diagram illustrating the configuration of the skin diagnostic apparatus according to the embodiment of the invention. As shown in FIG. 6, the skin diagnostic apparatus 20 according to this embodiment includes: an image retrieving unit 21 for retrieving the image, which has been obtained by photographing the face with the test sheet 1 adhered thereto, into the apparatus 20; an image processing unit 22 for applying predetermined image processing to the retrieved image to obtain a processed image; a moisture amount measuring unit 23 for measuring the amount of moisture evaporating through the skin surface based on the processed image; a surface information obtaining unit 24 for obtaining information of the skin surface based on the processed image; a memory 25 for storing various information; and an input/output unit 26 connected to a network for inputting and outputting various information to and from the apparatus 20, all of which are connected via a bus 27. In this embodiment, each pixel of the obtained processed image has R, G and B color signal values. The color signal values represent reflected densities (i.e., when all the R, G and B values are maximum values, the color represented by these values is black).

The image retrieving unit 21 is formed by a known interface for retrieving an image recorded in a memory card of the digital camera 10.

The image processing unit 22 applies, first, a process for compensating characteristics of the digital camera 10 to the image retrieved by the image retrieving unit 21. The purpose of this process is to eliminate differences in color reproduction characteristics between images obtained by different models of digital cameras due to different color reproduction characteristics of the different digital cameras.

The colors of the color areas 5A-5C of the first correction chart 5 on the test sheet 1 are known in advance, and R, G and B color values of the color areas 5A-5C are stored in advance in the memory 25 in this embodiment. The image processing unit 22 applies color conversion to the image to correct colors of the image so that the colors of the color areas 5A-5C contained in the image are matched with the original colors of the color areas 5A-5C stored in the memory 25.

Further, the lightness levels of the gray areas 6A-6C of the second correction chart 6 on the test sheet 1 are known in advance, and R, G and B color values of the gray areas 6A-6C are stored in advance in the memory 25 in this embodiment. The image processing unit 22 applies lightness conversion to the image to correct the lightness of the image so that the lightness levels of the gray areas 6A-6C contained in the image are matched with the original lightness levels of the gray areas 6A-6C stored in the memory 25.

Through the above-described processes, the image processing unit 22 obtains the processed image.

The moisture amount measuring unit 23 measures the amount of moisture evaporating through the skin based on the color of an area in the processed image corresponding to the reagent layer 4 (hereinafter referred to as a “reagent area”). In this embodiment, amounts of moisture corresponding to the respective colors of the color areas 5A-5C of the first correction chart 5 are stored in advance in the memory 25. Specifically, the amounts of moisture are stored such that blue corresponds to an amount of 0.1 mg/cm², pale flesh color corresponds to an amount of 0.2 mg/cm², and pale red corresponds to an amount of 0.4 mg/cm². The moisture amount measuring unit 23 calculates distances between the color of the reagent area and the blue, pale flesh and pale red colors in the RGB color space, respectively, and determines one of the amounts of moisture corresponding to the color having the smallest distance to the color of the reagent area as the amount of skin moisture of the user whose image has been measured.

For example, if the distance to the blue is the smallest, the amount of skin moisture is determined to be 0.1 mg/cm², if the distance to the pale flesh color is the smallest, the amount of skin moisture is determined to be 0.2 mg/cm², and if the distance to the pale red is the smallest, the amount of skin moisture is determined to be 0.4 mg/cm². It should be noted that the amount of moisture may be measured using interpolation based on the distances between the color of the reagent area and the blue, pale flesh and pale red colors in the color space.

The surface information obtaining unit 24 obtains surface information of the skin surface including age spot information and wrinkle information based on areas of the processed image other than the area corresponding to the test sheet 1. First, how the age spot information is obtained will be explained. For obtaining the age spot information, the surface information obtaining unit 24 plots a color of each pixel of the processed image in the RGB color space. Since normal skin and an age spot have apparently different colors, a space A1 for colors of the skin and a space A2 for colors of the age spots can be separated in the RGB color space, as shown in FIG. 7. The surface information obtaining unit 24 determines the pixels plotted in the space A2 as age spots, and obtains the colors and positions thereof in the processed image as the age spot information. The positions of the age spots are coordinate positions in an XY coordinate system defined on the processed image with the upper-left corner of the image being the origin.

It should be noted that the technique for obtaining the age spot information is not limited to the above-described technique. For example, a filter having a shape of an age spot may be used to extract an area having the age spot shape, and if the area has color values greater than predetermined values, the area may be detected as an age spot and the position and color of the detected area may be obtained as the age spot information.

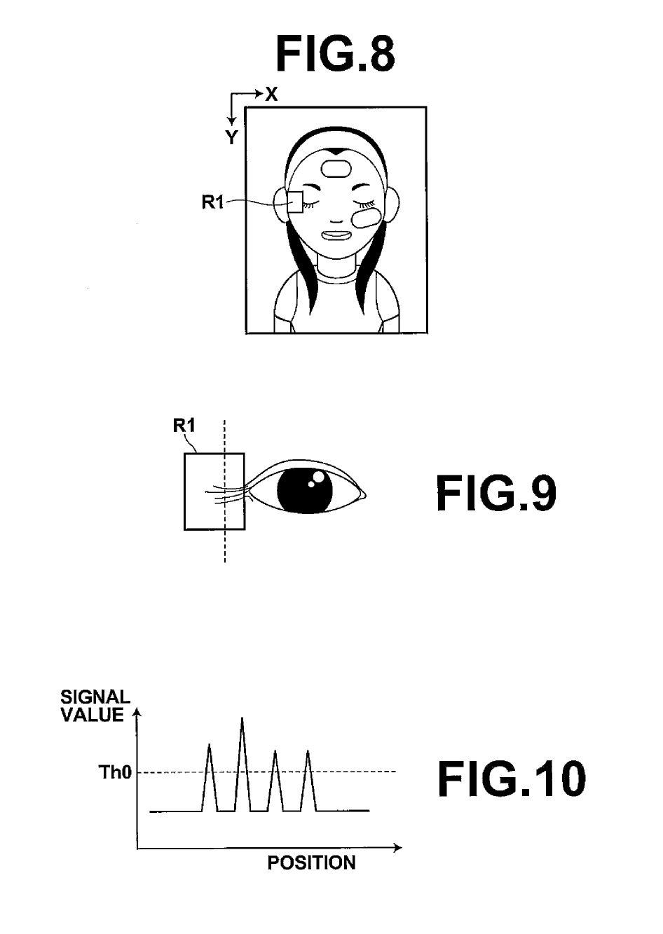

Next, how the wrinkle information is obtained will be explained. Wrinkles appear on the image as lightness (darkness) information. That is, wrinkle areas are darker than surrounding skin colors and peaks of darkness appear at the wrinkle areas. The surface information obtaining unit 24 sets a wrinkle detection window R1 on the processed image, as shown in FIG. 8, and detects one-dimensional profiles for both X and Y directions within the detection window R1 with the upper-left corner of the processed image being the origin. If the detection window R1 is set at the wrinkles at the outer corner of the eye as shown in FIG. 9, a profile of the signal values at positions along the dashed line in FIG. 9 has peaks corresponding to positions of the wrinkles as shown in FIG. 10. Therefore, the surface information obtaining unit 24 obtains the positions on the processed image of the pixels having the signal values greater than or equal to a threshold Th 0 in the profile and their signal values as the wrinkle information.

The input/output unit 26 is formed by a known network interface. Information of the moisture amount measured by the moisture amount measuring unit 23 and the surface information obtained by the surface information obtaining unit 24 are transmitted as skin information of the user via the input/output unit 26 to a diagnostic server, which analyzes the skin information of the user to diagnose the skin. A user ID for identifying the user is also transmitted together with the skin information.

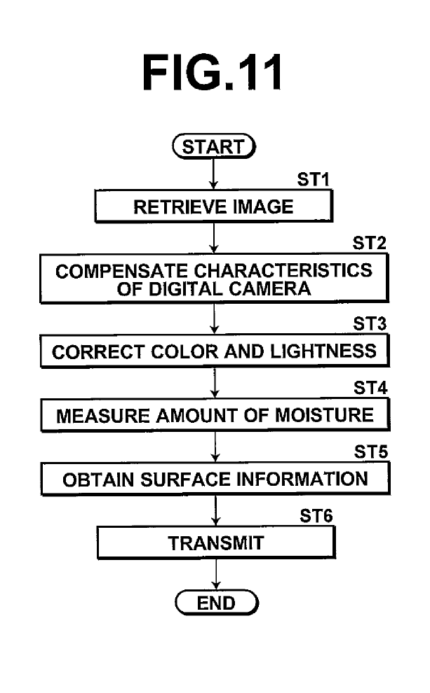

Next, a process carried out by the skin diagnostic apparatus 20 according to this embodiment will be explained. FIG. 11 is a flow chart illustrating the process carried out by the skin diagnostic apparatus 20 according to this embodiment. The image retrieving unit 21 retrieves an image to be processed (step ST1), and the image processing unit 22 applies to the image the process for compensating characteristics of the digital camera 10 (step ST2) and corrects the color and lightness of the image according to the first and second correction charts 5 and 6 to obtain the processed image (step ST3).

Subsequently, the moisture amount measuring unit 23 measures the amount of skin moisture based on the processed image (step ST4), and the surface information obtaining unit 24 obtains the skin surface information based on the processed image (step ST5). Then, the input/output unit 26 transmits the skin information of the user including the amount of moisture and the surface information to the diagnostic server (step ST6), and the process ends.

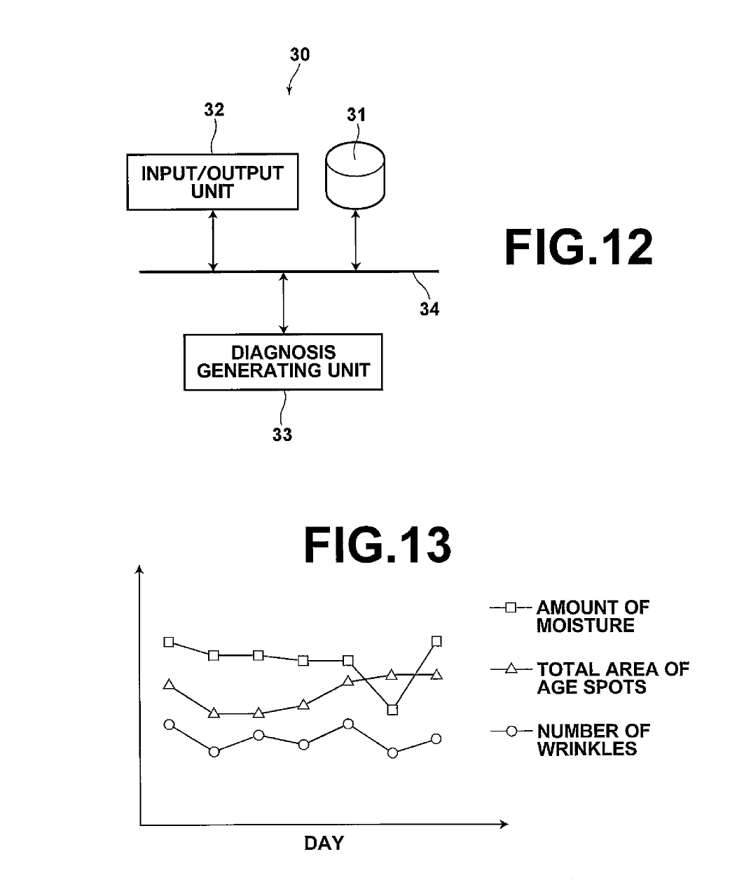

FIG. 12 is a schematic block diagram illustrating the configuration of the diagnostic server. As shown in FIG. 12, the diagnostic server 30 includes: a database 31 in which pieces of skin information of a lot of users are accumulated; an input/output unit 32 connected to a network for receiving the skin information and transmitting a diagnosis; and a diagnosis generating unit 33 for generating the diagnosis from the skin information with referencing the database 31, all of which are connected via a bus 34.

In the database 31, the pieces of skin information are registered for each user in time-series.

Based on the obtained user ID, the diagnosis generating unit 33 obtains previous skin information for the user of the user ID from the database 31, and creates a graph containing amounts of skin moisture, total areas of age spots and numbers of wrinkles from the previous skin information and the newly obtained skin information. For the amount of skin moisture, the amount of moisture contained in the transmitted skin information is used without any further calculation. For the total area of age spots, regions of age spots on the image are identified from the information of the positions of age spots, and areas of the identified age spot regions are summed up to obtain the total area. For the number of wrinkles, positions of wrinkles on the image are identified from the information of the positions of wrinkles, and the number of the identified wrinkles is counted.

FIG. 13 is a graph containing the amounts of skin moisture, the total areas of age spots and the numbers of wrinkles. From such a graph, one can know changes over time in the amount of skin moisture, the total area of age spots and the number of wrinkles.

Then, the diagnosis generating unit 33 references the created graph and the information registered in the database 31 to produce a diagnostic report representing a diagnostic result for the user. The diagnostic report contains, for example, a total evaluation on the skin condition, advice and tips for skin care, and prediction of future skin condition. Then, the created diagnostic report is transmitted to the user via e-mail or the like.

In this manner, the user can obtain the diagnostic report containing the diagnosis on her or his skin at her or his home, and can carry out skin care by herself or himself at her or his home.

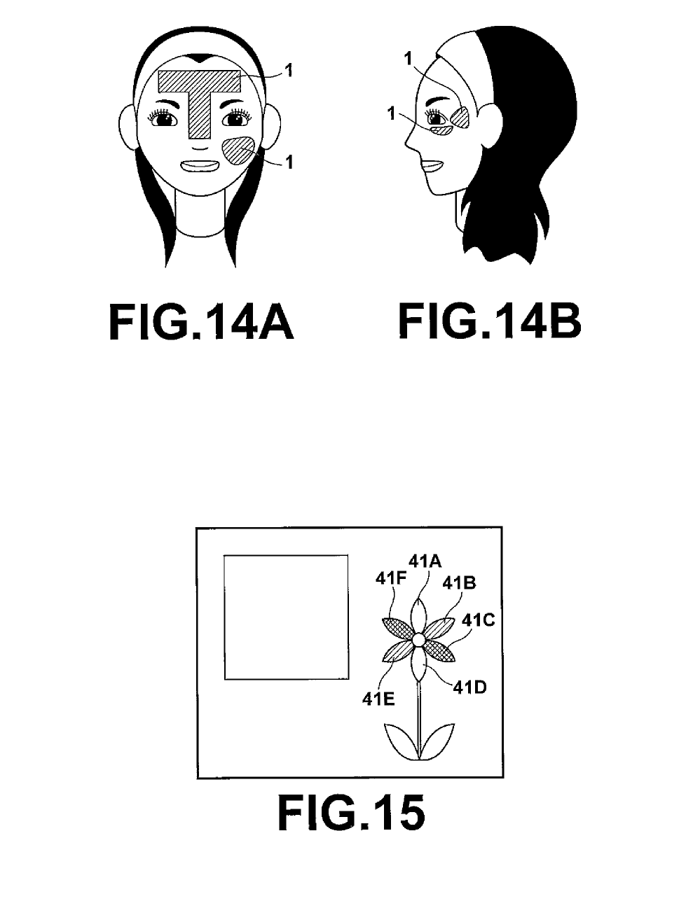

It should be noted that, although the rectangular test sheet 1 as shown in FIGS. 1 and 2 is used in the above-described embodiments, the shape of the test sheet may be altered depending on the position on the face where it is used. For example, as shown in FIGS. 14A and 14B, the test sheets adhered on the cheek, on the outer corner of the eye and under the eye may have inverted triangular shapes, and the test sheet adhered on the so-called T-zone, which is formed by the ridge of the nose and the horizontal line of the forehead, may be T-shaped.

In addition, the test sheets with different reagents may be used for different sites of the face. For example, since the amount of moisture is important for the cheek, the outer corner of the eye and the area under the eye, the test sheets having the reagent for measuring the amount of moisture may be adhered to these sites. On the other hand, what matters with the T-zone is sebum level, and therefore, the test sheet having the reagent for measuring the sebum level may be adhered to the T-zone.

Moreover, although the first and second correction charts 5 and 6 includes the color areas 5A-5C and the gray areas 6A-6C, respectively, in the above-described embodiments, an illustration may be provided to the test sheet 1 and the illustration may include areas of different colors and different lightness levels corresponding to the color areas 5A-5C and the gray areas 6A-6C. For example, as shown in FIG. 15, an illustration of a flower having six petals 41A-41F may be provided to the test sheet 1, and the six petals 41A-41F may have different colors corresponding to the color areas 5A-5C and different lightness levels corresponding to the gray areas 6A-6C.

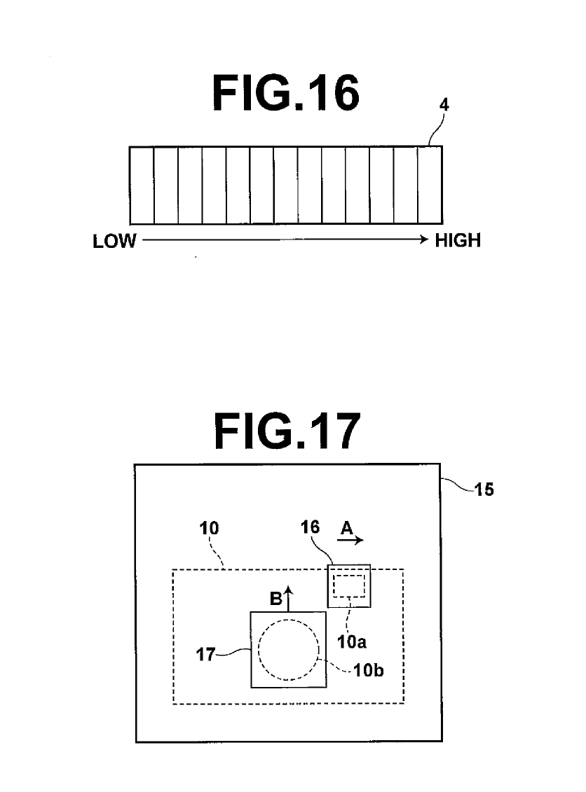

Further, concentration of the reagent provided in the reagent layer 4 of the test sheet 1 may be varied in a graduated manner. For example, as shown in FIG. 16, the concentration of the reagent may be varied in a graduated manner such that the leftmost section of the reagent layer 4 has the lowest concentration and the rightmost section has the highest concentration. It should be noted that, if the concentration of the reagent is high, a detectable amount of moisture is large; however, a rate of change of the color is small for a detected amount of moisture. In contrast, if the concentration of the reagent is low, a detectable amount of moisture is small; however a rate of change of the color is large for a detected amount of moisture. Therefore, by finding in advance an amount of moisture detectable by each section of the reagent layer having the different levels of concentration, which is detected when the color of the reagent changes from blue to pale red, the amount of moisture can be more accurately measured from the extent of the sections of the reagent layer 4 of the test sheet 1 where the color of the reagent has changed. Alternatively, the amount of moisture can be measured in the similar manner using the reagent layer 4 having a uniform concentration and the nonwoven fabric 7 having graduated levels of water permeability.

In a case where polarized light is directed to the skin, the light reflected at the surface of the skin stay polarized, while the light reaching inside the skin is scattered within the skin and is no longer polarized. Therefore, by directing the polarized light to the face and detecting the light reflected from the skin through a polarizing filter having a polarizing direction orthogonal to the polarization of the polarized light during photographing of the face with the digital camera 10, only the light scattered within the skin is detected. Age spots are present inside the skin. By detecting the reflected light through the polarizing filter, the light reflected at the surface of the skin can be removed and conditions of the age spots inside the skin can be accurately detected to be photographed.

The above-described application of polarized light and photographing can be achieved using the stand 16 shown in FIG. 5, where, as shown in FIG. 17, a polarizing filter 16 for polarizing light in the direction of arrow A in FIG. 17 is disposed at an area correspond to the flash 10a of the digital camera 10, and a polarizing filter 17 for polarizing light in the direction of arrow B, which is orthogonal to the direction of arrow A, is disposed at an area corresponding to the photographing lens 10b. Alternatively, an image composed only of the light reflected at the surface of the skin can be obtained by disposing a polarizing filter that polarize light in the direction of arrow A in place of the polarizing filter 17.

Further, although the test sheet for detecting the amount of moisture is adhered to the face and is photographed for diagnosis of the human skin in the above-described embodiments, the test sheet for detecting the amount of moisture or the like may be adhered to an object such as a fruit and be photographed to detect the amount of moisture and the surface condition of the object in the similar manner as the case of the human skin.

Furthermore, in the above-described embodiments, the database 31 and the diagnosis generating unit 33 may be included in the skin diagnostic apparatus 20 so that the graph of the amount of skin moisture, the total area of age spots and the number of wrinkles shown in FIG. 13 and the diagnostic report may be created in the skin diagnostic apparatus 20.

The skin diagnostic apparatus according to the embodiment of the present invention has been explained, however, the invention may also be implemented as a program for causing a computer to function as means corresponding to the above-described image processing unit 22, the moisture amount measuring unit 23 and the surface information obtaining unit 24 to carry out the process as shown in FIG. 11.

The test sheet of the present invention includes a reagent layer containing a reagent that changes the color thereof depending on an amount of substance evaporating from a surface of the object, a first correction chart used for correcting color of an image obtained by photographing the object having the test sheet adhered thereto, and a second correction chart used for correcting lightness of the image. Therefore, color of the image, which is obtained by adhering the test sheet to the surface of the object and photographing the object with the test sheet, can be corrected using the first correction chart. Further, lightness of the image can be corrected using the second correction chart. In this manner, influence of outside light on the color of the reagent and the lightness of the object during the photographing can be removed, and an amount of a substance evaporating from the surface of the object and information of the surface of the object can be obtained simultaneously and accurately.

By measuring and storing actual amounts of the substance corresponding to changes of the color of the reagent in the first correction chart in advance, a quantitative amount of the substance can be found.

According to the method for diagnosing an object of the invention, an image of an object with the test sheet of the invention adhered to a portion thereof is obtained, and color and lightness of the image are corrected based on the first and second correction chart. Then, an amount of a substance evaporating from the surface of the object is measured based on the color of the reagent contained in the processed image, and information of the surface of the object is obtained from areas of the object in the processed image. In this manner, influence of outside light on the color of the reagent and the lightness of the object during the photographing can be removed, and an amount of a substance evaporating from the surface of the object and information of the surface of the object can be obtained simultaneously and accurately.

By storing the amount of the substance and the information of the object surface, amounts of the substance and pieces of information of object surfaces for various objects can be obtained. By storing the amounts of the substance and the pieces of information of the object surface of the same object in an associated manner, changes over time of the amount of the substance and the information of the object surface for the same object can be learned.

What is claimed is:

1. A test sheet to be adhered to an object at the point of use, the test sheet comprising:
a substrate film including an adhesive layer on one side thereof;
a reagent layer disposed on the substrate film on the same side as the adhesive layer, the reagent layer including a reagent, the reagent changing the color thereof depending on an amount of substance evaporating from a surface of the object;
a first correction chart disposed on the substrate film on the side opposite from the adhesive layer, the first correction chart being used for correcting color of an image obtained by photographing the object with the test sheet adhered thereto; and
a second correction chart used for correcting lightness of the image.

2. The test sheet as claimed in claim 1, wherein the substrate film is made from a material having a refractive index substantially equal to a refractive index of the surface of the object.

3. The test sheet as claimed in claim 1, wherein the substrate film has surface characteristics substantially equal to surface characteristics of the object.

4. The test sheet as claimed in claim 1, wherein the reagent comprises at least one of cobalt chloride for measuring an amount of moisture, and BCP (bromcresol purple), MR (methyl red), CRP (chlorophenol red) and PP (phenol purple) for measuring pH.

5. The test sheet as claimed in claim 1, wherein the first correction chart comprises a color chart representing changes of the color of the reagent in a graduated manner.

6. The test sheet as claimed in claim 1, wherein the second correction chart comprises a gray chart including graduated lightness levels.

7. An apparatus for diagnosing an object, the apparatus comprising:
image obtaining means for obtaining an image of an object with the test sheet of claim 1 adhered to a portion thereof;
image processing means for correcting color and lightness of the image based on the first and second correction chart contained in the image to obtain a processed image;
substance amount measuring means for measuring an amount of a substance evaporating from the surface of the object based on the color of the reagent contained in the processed image; and
surface information obtaining means for obtaining information of the surface of the object based on the processed image.

8. The apparatus for diagnosing an object as claimed in claim 7, further comprising a storing means for storing in a database the amount of the substance and the information of the surface of the object.

9. A method for diagnosing an object, the method comprising:
obtaining an image of an object with the test sheet of claim 1 adhered to a portion thereof;
correcting color and lightness of the image based on the first and second correction chart contained in the image to obtain a processed image;
measuring an amount of a substance evaporating from the surface of the object based on the color of the reagent contained in the processed image; and
obtaining information of the surface of the object based on the processed image.

10. A computer readable recording medium containing a program for causing a computer to carry out a method for diagnosing an object, the method comprising:
obtaining an image of an object with the test sheet of claim 1 adhered to a portion thereof;
correcting color and lightness of the image based on the first and second correction chart contained in the image to obtain a processed image;
measuring an amount of a substance evaporating from the surface of the object based on the color of the reagent contained in the processed image; and
obtaining information of the surface of the object based on the processed image.

11. An apparatus for diagnosing an object, the apparatus comprising:
an image obtaining unit for obtaining an image of an object with the test sheet of claim 1 adhered to a portion thereof;
an image processing unit for correcting color and lightness of the image based on the first and second correction chart contained in the image to obtain a processed image;
a substance amount measuring unit for measuring an amount of a substance evaporating from the surface of the object based on the color of the reagent contained in the processed image; and
a surface information obtaining unit for obtaining information of the surface of the object based on the processed image.
